(19) United States
(12) Patent Application Publication
(10) Pub. No.: US 2025/0343505 A1
(43) Pub. Date: Nov. 6, 2025

(54) Increased-Yield Solar Energy Station

(71) Applicant: Envigor Energy, LLC, Thermopolis, WY (US)

(72) Inventor: John Newkirk, Thermopolis, WY (US)

(21) Appl. No.: 19/196,980

(22) Filed: May 2, 2025

Related U.S. Application Data
(60) Provisional application No. 63/642,137, filed on May 3, 2024.

(51) Int. Cl. H02S 40/22; H02S 20/10; H02S 20/23; H02S 20/32

(52) U.S. Cl. CPC H02S 40/22; H02S 20/10; H02S 20/23; H02S 20/32

(57) ABSTRACT

An increased-yield solar energy station is disclosed. In an example, an upper support structure of a base structure is raised off of the ground for mounting a photovoltaic (PV) array to the base structure. An interior portion of the base structure at least partially shields balance of system (BOS) components for the PV array from effects of weather. At least one bifacial photovoltaic (PV) panel of the PV array, and is mounted in a raised position relative to the upper support structure. The bifacial PV panel has a first side facing toward the sky, and a second side facing away from the sky. Both the first and second sides of the bifacial PV panel have solar cells for collecting solar energy. A solar reflective material (SRM) on the upper support structure reflects sunlight from the upper support structure onto the second side of the bifacial PV panel.

### PRIORITY CLAIM

This application claims the priority filing benefit of U.S. Provisional Patent Application No. 63/642,137 filed May 3, 2024 for “Increased-Yield Solar Energy Station” of John Newkirk, hereby incorporated by reference in its entirety as though fully set forth herein.

### BACKGROUND

Rural areas have long faced the challenge of reduced access to reliable electrical power. Solar electricity offers a sustainable, environmentally friendly, and increasingly affordable augmentation to traditional energy sources, yet many residents of rural and underserved communities have been hesitant to embrace this technology. Rural areas have historically faced significant challenges in accessing reliable electrical power. This lack of consistent energy access can hinder economic development, limit access to essential services, and impact the overall quality of life for residents. Traditional energy infrastructure, often designed to serve densely populated areas, may not extend efficiently or affordably to remote or sparsely populated rural communities. Consequently, residents in these areas may experience frequent power outages, voltage fluctuations, or even lack of grid connection altogether.

Solar electricity presents a viable solution to these challenges. As a sustainable and environmentally friendly alternative to traditional fossil fuel-based energy sources, solar power can be deployed in a decentralized manner, making it suitable for areas where extending the existing grid is impractical or cost-prohibitive. Moreover, advancements in solar technology have led to increased efficiency and affordability, making it more accessible to a wider range of consumers. However, despite these advantages, the adoption of solar energy in rural and underserved communities has been slower than anticipated. Various factors contribute to this hesitancy, including lack of information, skepticism toward renewable energy, financial constraints, and concerns about the reliability and maintenance of solar systems.

Addressing these concerns and promoting the adoption of solar energy in rural areas requires a multifaceted approach. It involves educating communities about the benefits of solar power, providing financial incentives or subsidies to make it more affordable, and developing user-friendly and reliable solar solutions that meet the specific needs and preferences of rural residents. By overcoming these barriers and fostering a greater understanding and acceptance of solar technology, it is possible to significantly improve energy access and promote sustainable development in rural and underserved communities.

### BRIEF DESCRIPTION OF THE DRAWINGS

FIG. 1 shows an example of an increased-yield solar energy station implemented as an outbuilding.

FIG. 2 is a partial cutaway front view of the increased-yield solar energy station shown in FIG. 1.

FIG. 3 is a partial cutaway rear view of the increased-yield solar energy station shown in FIG. 1.

FIG. 4 is a side view of solar panels mounted to the increased-yield solar energy station shown in FIG. 1.

FIG. 5 is a close-up view corresponding to FIG. 4 showing a bifacial aspect of the solar panels mounted to the increased-yield solar energy station.

FIG. 6 shows another example of an increased-yield solar energy station implemented as a geodesic structure.

FIG. 7 shows another example of an increased-yield solar energy station implemented as a ground-mounted structure.

FIGS. 8-9 illustrate assembly of the increased-yield solar energy station of FIG. 7.

### DETAILED DESCRIPTION

Widespread availability of economical photovoltaic panels has revolutionized the renewable energy sector. Over the past decade it has become increasingly popular for suburban homeowners to “go solar” by hiring contractors to install PV panels on their rooftops. Once limited to specialty solar firms, many consumer wholesalers are now promoting solar energy. Costco stores, for example, feature a dedicated solar sales booth. Home Depot offers solar panels and installation services. Even Walmart sells a “home solar power kit.”

Reviews and reception, however, have been mixed during this recent upsurge, especially in America's rural, western, and other underrepresented areas where opinions on renewable energy vary to a large degree. With regard to solar and other forms of renewable energy, many rural and underserved communities remain under-informed as to the significant benefits thereof. Many also feel that large-scale solar sites are being involuntarily placed in their backyards, and are regrettably developing a broad-brush opposition to alternative energy systems.

A significant portion of the rural population openly expresses skepticism toward decarbonized energy, even to the point of outright resentment. Fewer than 1% of Wyoming homes currently have rooftop solar. The number is even lower in Idaho, Montana, and the Dakotas (all of which declined to apply for 2023 Federal NOFO “Solar for All” grants). This is unfortunate, as many of these areas offer prime conditions for solar energy systems.

While roof-mounted solar installations have gained traction in densely populated urban areas, many rural homeowners express reluctance towards them due to a variety of concerns. One significant concern revolves around the potential for roof damage and subsequent leaks that could occur as a result of installing and maintaining solar panels. Rural homeowners often value the integrity and longevity of their roofs, and any risk of damage is a major deterrent. Furthermore, accessing roof-mounted panels for maintenance or snow removal can be challenging, especially on roofs with steep pitches or those frequently covered in snow and ice, which are common in many rural regions. This accessibility issue raises concerns about the practicality and safety of roof-mounted systems for rural residents.

Spatial and geometric constraints of existing roofs can limit the size and configuration of a photovoltaic (PV) array. Rural homes may have roofs with complex shapes or limited south-facing areas, which can restrict the amount of solar energy that can be captured. This limitation can make roof-mounted systems less efficient or less cost-effective for rural homeowners. Obtaining necessary permits from local authorities also adds complexity and potential delays to the installation process. Rural areas may have varying regulations and requirements, leading to a more challenging permitting process compared to urban areas. Finally, the prospect of having to remove and reinstall the entire solar array if the roof needs to be replaced within the lifespan of the panels is a major deterrent. This costly and time-consuming process adds another layer of concern for rural homeowners considering roof-mounted solar installations.

To effectively advocate for widespread adoption of photovoltaics, one must first gain an understanding of what motivates certain population sectors to invest in solar technology. Research shows that this motivation varies according to demographics. Urban adopters, for example, tend to place greater value on decreased carbon footprints, lower electrical bills, tax credits, and other tangible benefits of grid-tied solar installations. Rural residents tend to view solar as a) a tool of necessity in places where electricity is not readily available and b) an instrument of self-reliance in the face of an aging, stressed, and often unreliable power grid. Furthermore, many rural electorates openly oppose large-scale solar installations, claiming negative impacts to the environment and to their quality of life. Reflective of this trend, as of 2024 at least 15% of U.S. counties have effectively halted new construction of utility-scale solar and wind projects.

The example increased-yield solar energy station disclosed herein can help shift this rural paradigm by developing a compact, affordable, turnkey alternative to the solar status quo.

Unlike urban developments with tightly-spaced homes, rural residents typically have room to place a small outbuilding or utility shed on their property—and they very frequently do so. Outbuildings, such as sheds, generally require no permits, are simple to set in place, and are an economical alternative to long-term rentals of self-storage units. The example increased-yield solar energy station combines this rural inclination for outbuildings and increased energy autonomy into an increased-yield solar energy station (or “smart shed”) that includes both building-integrated photovoltaics (BIPV) and balance of system (BOS) components.

An increased-yield solar energy station is disclosed which provides a compact, affordable, turnkey, and localized rural solar power station with widespread potential to benefit both society and historically underrepresented demographics within the United States.

An example of an increased-yield solar energy station is a compact solar power plant that can supply the electrical needs of a typical rural home. The unique solar station can be in the form of a small utility shed, a geodesic dome or partial dome, or other ground mounted structure. Furthermore, these configurations may include specially designed facets to maximize solar production throughout the day, providing a convenient, affordable, and efficient alternative to traditional solar energy installations.

In an example, the increased-yield solar energy station is a compact, consolidated solar power plant capable of generating up to 29 kWh (the average daily U.S. household electrical use) of clean electricity per day. This power plant includes building-integrated photovoltaics, and internal balance of system components, and may be enabled for virtual tracking of the sun. The solar panels can occupy as little surface area as the size of a full size pickup truck, parking space, etc. Incorporation of offset bifacial panels is projected to increase solar energy yield by 20% over typical roof installations.

Before continuing, it is noted that as used herein, the terms “includes” and “including” mean, but is not limited to, “includes” or “including” and “includes at least” or “including at least.” The term “based on” means “based on” and “based at least in part on.”

The term “photovoltaics” (also abbreviated as PV) as used herein, refers to the conversion of light (photons) into electricity (voltage) using semiconducting materials that exhibit the photovoltaic effect, a phenomenon studied in physics, photochemistry, and electrochemistry.

The term “bifacial panel” as used herein, refers to a solar panel that can generate electricity from both its front and back sides, increasing energy yield compared to traditional single-sided panels.

The term “balance of system” (also abbreviated as BOS) as used herein, refers to all components of a photovoltaic system other than the photovoltaic panels themselves. This includes inverters, batteries, wiring, mounting hardware, and other necessary equipment.

The term “grid-tied” as used herein, refers to electricity which is connected to the main electrical power grid, allowing for the exchange of electricity between the solar system and the grid.

The terms “inverter” and “charger” as used herein, refer to an electronic device that converts direct current (DC) electricity from solar panels or batteries into alternating current (AC) electricity used by most household appliances, and may also charge batteries.

The term “geodesic dome” as used herein, refers to a spherical or partial-spherical structure made up of interconnected triangles, hexagons, or other polygonal structures that provide strength and stability while enclosing a large space.

The term “gambrel roof” as used herein, refers to a roof with two slopes on each side, the lower slope having a steeper pitch than the upper slope.

The term “virtual tracking” as used herein, refers to a method of optimizing solar energy capture by designing a fixed array with geometry and panel orientation that maximizes sunlight absorption at various times of the day, rather than using mechanical tracking systems.

The term “solar reflective material” (also abbreviated as SRM) as used herein, refers to a material designed to reflect a high percentage of solar radiation, reducing heat absorption and increasing light available to the underside of bifacial panels.

The term “turnkey” as used herein, refers to a product or service that is ready for immediate use by the buyer, requiring no additional assembly or installation.

The term “decarbonized energy” as used herein, refers to energy produced with minimal or no carbon emissions, typically referring to renewable energy sources like solar and wind.

The term “effective daily yield” (also abbreviated as EDY) as used herein, refers to the actual amount of energy produced by a solar system over the course of a day, taking into account factors like weather, sun angle, and system efficiency.

The term “HUBZone” as used herein is an abbreviation for “Historically Underutilized Business Zone,” a U.S. program designed to stimulate economic development and create jobs in designated areas.

The term “NOFO” Notice of Funding Opportunity, a public announcement issued by a U.S. federal agency stating that grant funding is available.

It is also noted that the examples described herein are provided for purposes of illustration, and are not intended to be limiting. Other devices and/or device configurations may be utilized to carry out the operations described herein.

The operations shown and described herein are provided to illustrate example implementations. It is noted that the operations are not limited to the ordering shown. Still other operations may also be implemented.

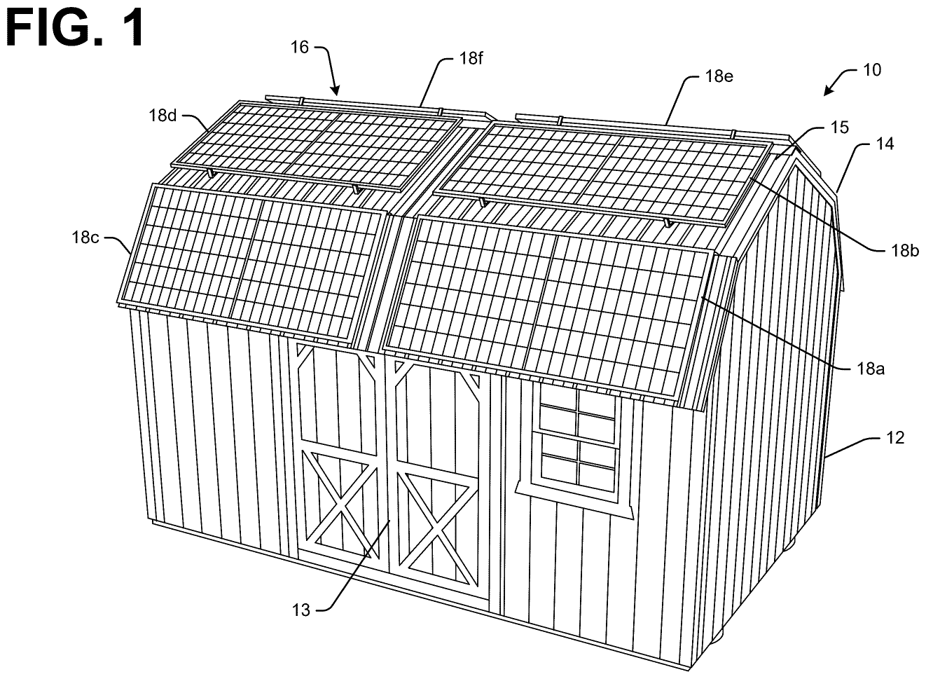

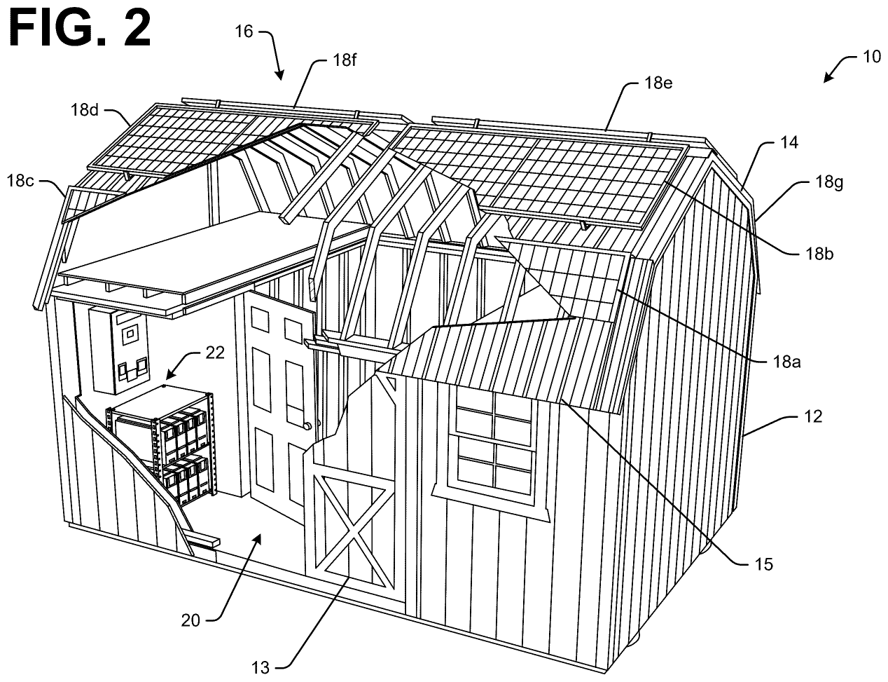

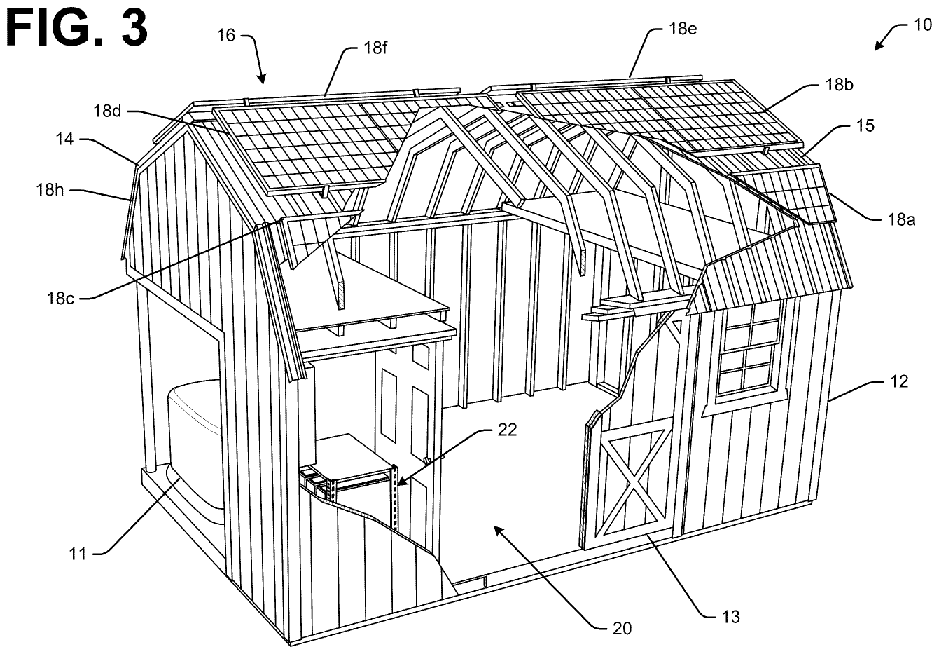

FIG. 1 shows an example of an increased-yield solar energy station 10 implemented as an outbuilding. FIG. 2 is a partial cutaway front view of the increased-yield solar energy station 10 shown in FIG. 1. FIG. 3 is a partial cutaway rear view of the increased-yield solar energy station 10 shown in FIG. 1. An example of an increased-yield solar energy station 10 includes a base structure 12 for contacting the ground. In this example, the base structure 12 is configured as an outbuilding. An upper support structure 14 of the base structure 12 is installed so that it is raised off of the ground. In this example, the upper support structure 14 is configured as the roof of the outbuilding. The upper support structure 14 is configured for mounting a photovoltaic (PV) array 16 to the base structure 12. In this example, the PV array 16 includes a plurality of solar panels 18a-h. A backup generator 11 may also be provided in the event of multiple sunless days or unusually high power demands that exceed the capabilities of the solar panels. An interior portion 20 of the base structure 12 provides at least partially shielding or protection of so-called balance of system (BOS) components 22 for the PV array 16 from effects of weather. Negative effects of weather may include, for example, wind, rain/snow/ice and the damaging effects of ultraviolet (UV) light from the sun.

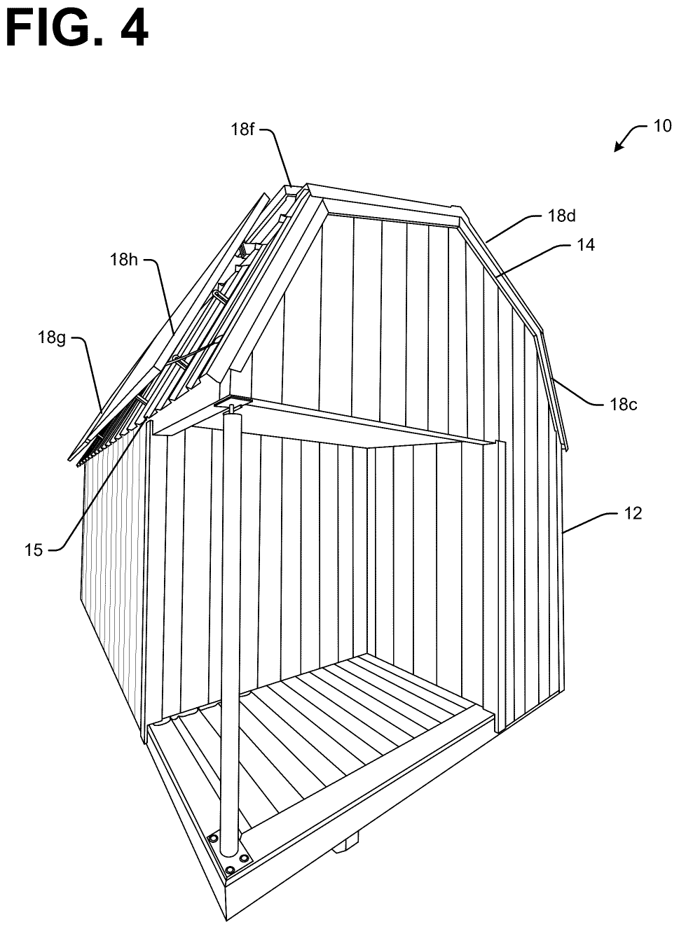

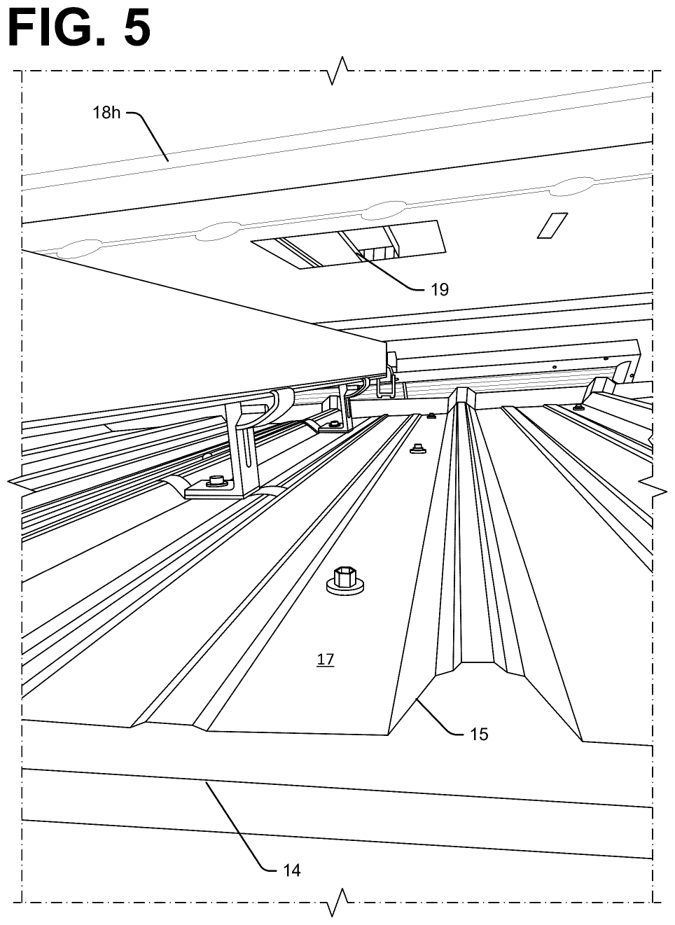

The PV array 16 has one or more bifacial photovoltaic (PV) panels 18a-h. The bifacial PV panels 18a-h are mounted in a raised position relative to the upper support structure 14. For example, the PV panels 18a-h may be mounted over the roof with a space defined therebetween. The bifacial PV panels 18a-h each have a first side (e.g., top) oriented to face toward the sky, and a second side (e.g., bottom) oriented to face away from the sky (e.g., facing toward the roof. Both the first and second sides of the bifacial PV panels 18a-h have solar cells for collecting solar energy. Solar energy may be direct, incident, or from beneath (e.g., reflected from the roof) as will be described in more detail below with reference to the example shown in FIGS. 4 and 5.

The base structure 12 is illustrated in FIGS. 1-3 configured as a storage shed or other outbuilding having sidewalls and a roof forming the interior portion. One or more doors 13 provide access to the BOS components 22 within the interior portion 20.

In an example, the bifacial PV panels 18a-h are mounted to a gambrel roof of the outbuilding. FIGS. 1-3 show an example of an increased-yield solar energy station with eight bifacial PV panels 18a-h integrated onto a specially modified gambrel roof. In this example, the roof is coated with a solar reflective material (SRM) and the PV panels 18a-h are raised such that sufficient light may be reflected from the roof to reach the underside of the PV panels 18a-h.

To enhance the efficiency of bifacial photovoltaic (PV) panels 18a-h, the use of solar reflective materials (SRMs) is a critical component. These materials are designed to reflect sunlight onto the underside of the bifacial PV panels, enabling them to capture additional solar energy. Examples of SRMs include reflective paints, pre-coated metal panels, or specialized reflective films. Reflective paints, such as titanium dioxide-based coatings, are popular for their affordability and ease of application. Pre-coated panels may also be provided. These panels can be made of aluminum or steel with reflective finishes, to provide durability, and are ideal for large-scale installations. Reflective films, on the other hand, are highly versatile and can be applied to various surfaces, offering excellent reflectivity. The choice of SRM depends on factors such as, but not limited to, budget, durability requirements, and the specific installation environment.

Positioning the PV panels 18a-h at a desired height above the reflective material helps to maximize energy capture. Raising the PV panels 18a-h too close to the SRM can obstruct the effective reflection of sunlight onto the underside of the panels, while mounting the PV panels 18a-h too high may lead to inefficient light diffusion. In an example, a gap of 1 to 12 inches between the SRM and the PV panels 18a-h provides a desired balance. This spacing helps ensure that sunlight can be reflected directly onto the underside of the PV panels 18a-h without significant energy losses. Additionally, the angle of the PV panels 18a-h and the tilt of the reflective surface can be configured to complement each other to optimize light reflection and absorption.

Careful consideration of these factors during the assembly process can impact the performance of the solar energy station 10. Regular maintenance, such as cleaning the reflective material to maintain reflectivity, also plays a role in sustaining efficiency over time. With the correct SRM, proper spacing, and attention to detail, bifacial PV systems can achieve improved energy yields, making them a valuable choice for sustainable energy generation.

In the example shown, the interior 20 of the outbuilding includes a closet with an inverter/charger, batteries, and other BOS components that allow full grid-tie with 200 amp passthrough. The remainder of the outbuilding is open, with over 200 sq ft (including lofts) available for storage or customization.

FIG. 4 is a side view of the solar panels (panel 18a is visible in this view) mounted to the increased-yield solar energy station 10 shown in FIG. 1. FIG. 5 is a close-up view corresponding to FIG. 4 showing a bifacial aspect of the solar panels mounted to the increased-yield solar energy station.

In an example, at least one of the bifacial PV panels 18a-h is mounted above a top surface 14 of the gambrel roof 15 of the outbuilding at a distance such that sunlight reaches the solar cells 19 on the second side (e.g., the underside oriented to face away from the sky) of the PV panels 18a-h.

In an example, PV panels 18a-h are mounted above a top surface 14 of the gambrel roof 15 of the outbuilding at a distance such that wind passes between the PV panels 18a-h and the top surface 14 of the of the gambrel roof 15 of the outbuilding, thereby decreasing effective wind load. Instead, or in addition to spacing between the roof and the PV panels 18a-h, space may be provided between adjoining PV panels 18a-h to effectively make the PV array a sieve (letting wind pass through) instead of a sail (catching the wind).

In an example, a solar reflective material (SRM) 17 is provided on the upper support structure (e.g., coated on the gambrel roof 15). The SRM 17 reflects sunlight from the upper support structure 14 (e.g., the gambrel roof 15) in the gap seen in FIG. 5 and onto the second side of the bifacial PV panel 18a.

The example increased-yield solar energy station 10 can includes non-traditional solar array geometrics which are optimized with the latest bifacial panel technologies to maximize solar gain under typical meteorological patterns of cloud buildup during peak production hours. The example increased-yield solar energy station 10 can also be implemented for commercialization of affordable, compact, turnkey solar power plants requiring minimal maintenance and no invasive modifications to existing roofs or structures, which decrease grid load while encouraging underserved and rural residents to take a fresh look at adopting decarbonized energy.

In an example, a solar tracker can be provided (e.g., mounted to the base structure 12 or upper support structure 14 of the outbuilding) to track available sunlight for energy production by the PV array 16. In an example, the solar tracker is an active solar tracker. That is, the active solar tracker tracks the sun using electronic sensors and motor or actuator drives. In another example, the solar tracker is a virtual solar tracker. That is, the virtual solar tracker includes a computer model of a solar tracking system that can be created in various software platforms like MATLAB™ or custom software to determine the path of the sun based on time of day, time of year, weather patterns, etc.

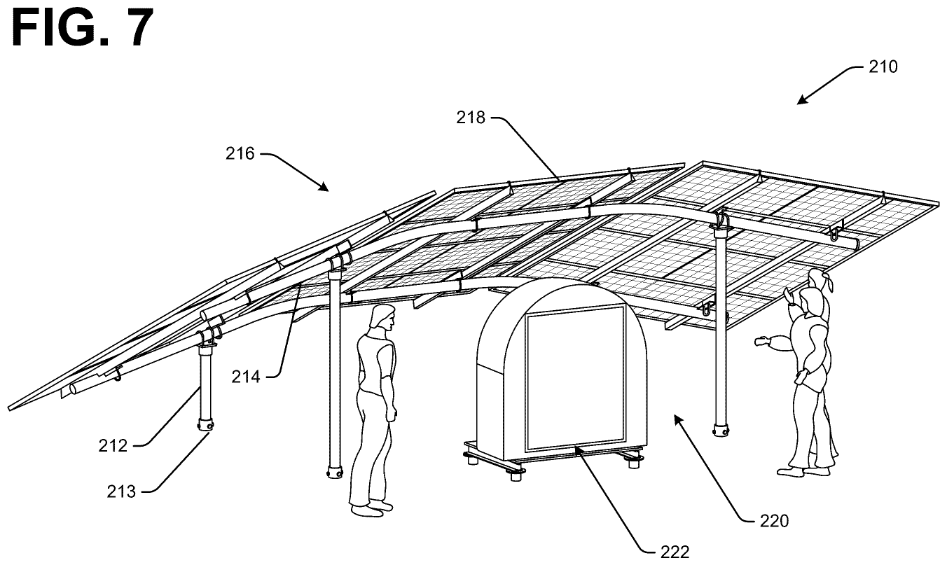

The PV panels 18a-h can be configured to be adjusted (either manually or automatically such as by electric motors). Other sensors may also be provided to provide feedback (e.g., windspeed sensors). By monitoring and adjusting array geometry, panel orientation, virtual tracking, evolving weather norms, efficient components, and other pertinent factors, optimum solar energy production of about 29 kWh per day (which, as of 2023, is America's average daily household electrical use) can be achieved. To obtain still higher yields, the systems are capable of an additional 10 KW of PV panels mounted via ground screws (e.g., as shown by the freestanding example in FIG. 7 which may be provided adjacent or nearby the outbuilding).

As noted above, the Figures illustrate a non-traditional panel orientation. That is, while North American photovoltaic designs have long favored south facing, coplanar, fixed PV arrays, such geometry is necessarily a compromise, as the optimum solar angle technically occurs just once per year. Moreover, the well-intentioned “due south” orientation is often thwarted by weather patterns now prevalent in the western United States. By the time the sun reaches its optimum angle, it is often obscured by cloud buildup.

The interval known as “Morning Daylight” extends from when the sun rises until noon local time. Western weather tends to be more stable with abundant morning sun, but this stability significantly decreases as the sun hits its peak. Unstable conditions often result in the formation of cumulus clouds which prevent direct sunlight from reaching photovoltaic panels. Stability generally returns by late afternoon and early evening when clouds tend to clear. The increased-yield solar energy station 10 is capable of “harvesting” sunlight at times when the sunlight is most prevalent.

In an example, the solar tracker can be implemented to maximize the efficiency of the photovoltaic (PV) array by continuously tracking and responding to available sunlight throughout the day. By leveraging real-time adjustments in array geometry and panel orientation, the system can maintain the panels at an optimal angle for capturing solar energy. Advanced tracking technologies-such as virtual tracking systems-monitor factors like evolving weather patterns and the performance of system components to dynamically adapt to environmental conditions. These adjustments collectively enable the solar energy station to produce an impressive yield of approximately 29 kilowatt-hours (kWh) daily.

For further enhancements in energy production, the system also supports the installation of additional PV panels to boost its capacity. Up to 10 kilowatts (kW) of panels can be mounted using ground screws, providing a sturdy foundation for expansion. This capability allows users to scale their solar energy station based on their energy needs, further increasing yields and supporting a sustainable energy solution. The combination of solar tracking and modular capacity upgrades makes the increased-yield solar energy station 10 a versatile and efficient choice for renewable energy production.

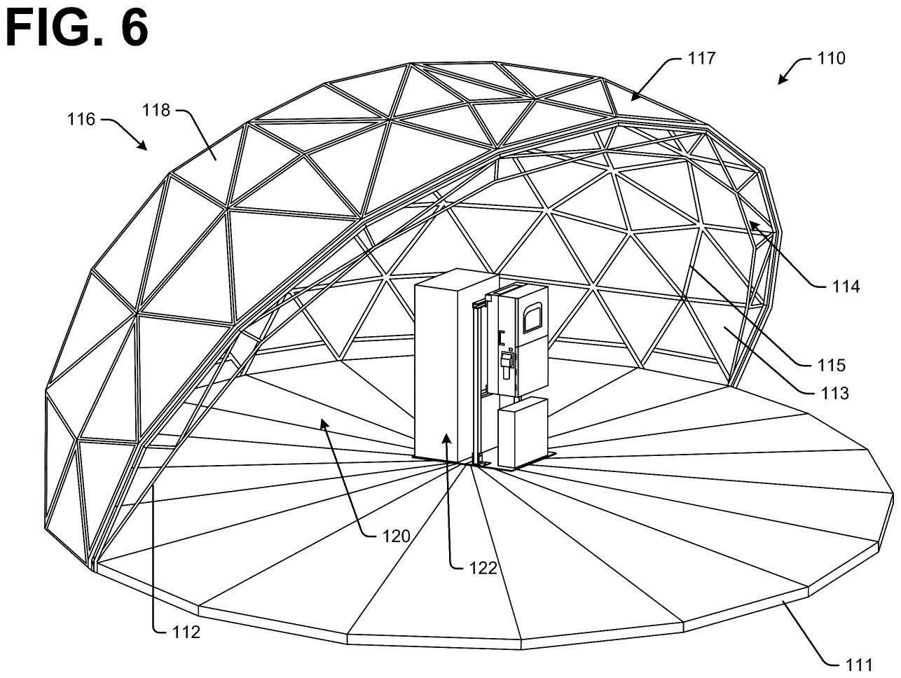

FIG. 6 shows another example of an increased-yield solar energy station 110 implemented as a geodesic structure. The increased-yield solar energy station 110 includes a base structure 112 for contacting the ground. In this example, the base structure 112 is a geodesic structure formed by a network of interconnecting polygonal panels 117 that form a spherical or semi-spherical shell 114 over the interior portion 120.

In an example, the upper support structure 114 or shell is formed by the base structure 112. The upper support structure 114 is the portion that is raised off of the ground. The upper support structure 114 is provided for mounting a photovoltaic (PV) array 116 having one or more PV panels 118 thereon.

In an example, some or all of the bifacial photovoltaic (PV) panels 118 of the PV array 116 can be mounted in a raised position relative to the upper support structure 114, similar to that already shown in FIG. 5 for the outbuilding. For example, the base structure 112 may include an upper support structure 114 formed by frame members 115 (e.g., the members outlining the structure or perimeter of the triangle or other polygon shapes). Cover panels 113 may be mounted to the frame members and positioned over the openings between the frame members 115, at least partially covering the triangle or other polygon shapes. The PV panels 118 can then be attached to the frame members 115 and/or cover panels 113 themselves to sit above the cover panels 113.

In another example, the geodesic structure itself is formed by a network of interconnecting polygonal panels 117 mounted to one another and/or to the frame members 115. Some or all of the polygonal panels 117 can be the PV panels 118 and/or the cover panels 113. As such, some or all of the PV panels 118 themselves form a shell or covering of the geodesic structure.

In each of these examples, the shell of the upper support structure 114 forms a protected interior portion of the base structure 120. This shell can be configured to at least partially shield balance of system (BOS) components 122 (for the PV array 116) from the effects of weather.

In each of these examples, the upper support structure 114 and panels (be those PV panels 118 and/or cover panels 113) form a spherical or semi-spherical shell over the interior portion 120, referred to as a geodesic structure. The geodesic structure is configured such that at any given daylight hour one or more of the PV panels 118 mounted to the shell are positioned on the geodesic structure to be oriented at or close to an angle that is perpendicular to the sun as the sun moves across the sky.

In addition, the PV panels 118 may be bifacial. That is, the bifacial PV panels have a first side oriented to face toward the sky, and a second side oriented to face away from the sky. Both the first and second sides of the bifacial PV panels 118 have solar cells for collecting solar energy both above and underneath, as already described above with reference to the outbuilding. Indeed, the geodesic structure may be said to be an “outbuilding” of another configuration.

In an example, a solar reflective material (SRM) is provided (e.g., sprayed or coated) to reflect sunlight onto the underside of the PV panels 118. For example, the SRM can be provided on the upper support structure 114 where the panels are mounted above cover panels forming the geodesic structure. In this example, the SRM reflects sunlight onto the second side (e.g., underside facing away from the sun) of the bifacial PV panels 118.

In another example, the SRM can be provided on a housing for the BOS components 122. For example, the BOS components 122 can be housed in a reflective enclosure that reflects sunlight onto the underside of the PV panels 118.

In another example, the SRM can be provided on at least a part of the floor structure 111 that reflects sunlight onto the underside of the PV panels 118.

Still other examples are contemplated for providing a SRM to maximize solar gain to the underside of the bifacial PV panels 118.

In an example, a solar tracker and/or other tracking and sensor equipment can be provided to track available sunlight for energy production by the PV array 116.

In an example, the bifacial PV panels 118 are mounted to the geodesic structure over at least one of the interconnecting polygonal panels 117.

In an example, the solar reflective material (SRM) is applied as a coating to one or more of the interconnecting polygonal panels 117.

In an example, the bifacial PV panels 118 are mounted above a top surface of the interconnecting polygonal panels 117 at a distance such that sunlight reaches the solar cells on the second side of the at least one bifacial PV panel oriented to face away from the sky. Refer again to the description of FIG. 5 for the outbuilding.

In an example, the bifacial PV panels 118 are mounted within a geodesic or partial geodesic frame, with the panels separated from one another at a distance such that wind passes between the interconnecting polygonal panels 117, thereby decreasing effective wind load. This can be the same space between the panels that also allows sunlight to pass through into the interior area of the geodesic structure and reflect from the BOS component enclosure and/or floor, sending light to the underside of the bifacial PV panels and increasing solar yield and energy generation.

FIG. 7 shows another example of an increased-yield solar energy station 210 implemented as a ground-mounted structure. For homes with covenants or other issues precluding an outbuilding or shed, FIG. 7 shows a ground-mounted design without an outbuilding or geodesic structure. In this example, a PV array 216 is shown mounted on a base structure 212 that is set into the ground with ground screws 213. Ground screws are large, helical screws designed to be driven into the ground to create a foundation for structures like decks, fences, or sheds. Ground screws provide an environmentally friendly and cost-effective alternative to concrete foundations. However, concrete foundations may also be provided. The base structure 212 supports an upper support structure 214. The upper support structure 214 at least partially covers or envelopes an enclosure 220 housing BOS components 222. The upper support structure also supports a PV array 216.

The upper support structure 214 is raised off of the ground for mounting a photovoltaic (PV) array 216 to the base structure 212. In the example shown in FIG. 7, the base structure 212 is a frame formed by a network of interconnecting frame members, at least some of the frame members contacting the ground (e.g., via groundscrews 213), and at least some of the frame members forming the upper support structure 214 provided to form the interior portion 220 thereof.

The interior portion 220 of the base structure 212 at least partially shields balance of system (BOS) components 222 for the PV array 216 from effects of weather. At least one bifacial photovoltaic (PV) panel 218 of the PV array 216 is mounted in a raised position relative to the upper support structure 214. The upper support structure 214 can be sheathed. The sheathing is not shown in FIG. 7, but can be provided similarly to the roof of the outbuilding and/or panels of the geodesic structure already discussed above. The sheathing can be coated with solar reflective material to optimize production from the bifacial panels 218. The bifacial PV panels 218 have a first side oriented to face toward the sky, and a second side oriented to face away from the sky. Both the first and second sides of the bifacial PV panels 218 have solar cells for collecting solar energy.

In an example, a solar tracker may track available sunlight for energy production by the PV array 216, which in this example has one facet facing southeasterly, one facet facing due south, and the remaining facet facing southwesterly so as to effectively harvest sunlight throughout the day.

In an example, the bifacial PV panels 218 can be mounted above a top surface of the upper support structure 214 at a distance such that sunlight reaches the solar cells on the second side of the at least one bifacial PV panel 218 oriented to face away from the sky. Alternatively, the bifacial PV panels 218 may be mounted on the upper support structure 214, and sunlight is reflected onto the underside of the PV panels 218, e.g., from the ground. In such an example, the ground may be provided with a base material that aids in reflecting sunlight to the underside of the PV panels 218.

In an example, the bifacial PV panels 218 are mounted such that wind passes under and/or between the bifacial PV panels 218, thereby decreasing effective wind load.

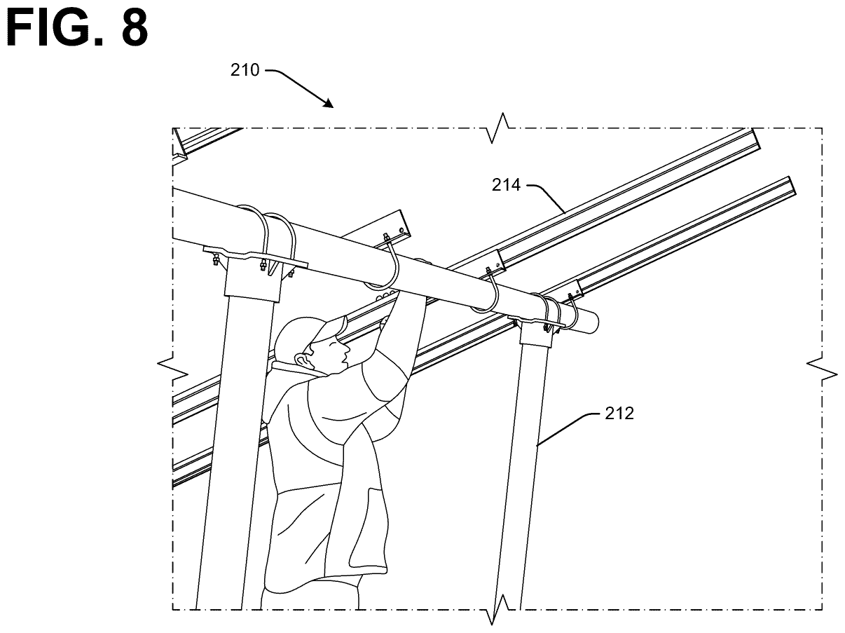

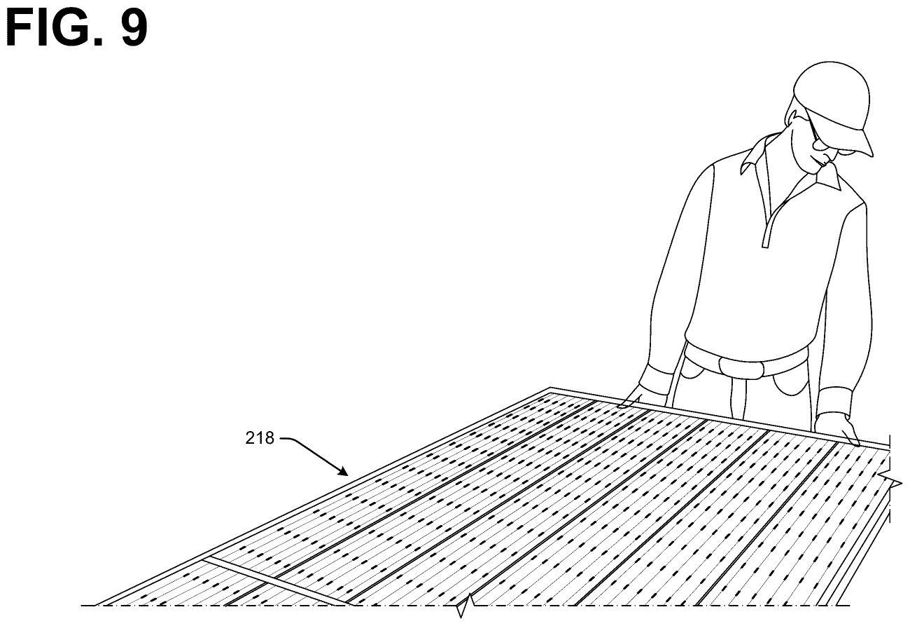

FIGS. 8-9 illustrate assembly of the increased-yield solar energy station of FIG. 7. These assembly instructions are illustrative and not intended to be a nonlimiting step-by-step guide to constructing an increased-yield solar energy station 210. The assembly instructions cover the installation of the base structure 212, upper support structure 214, balance of system (BOS) components 222, and bifacial photovoltaic (PV) panels 218.
Step 1: Assemble the Base Structure 212. Prepare the ground area where the base structure 212 will be installed. Position the base structure 212 so that it securely contacts the ground (e.g., using ground screws or concrete footers). Ensure the base structure 212 is level and stable to provide a firm foundation.
Step 2: Attach the Upper Support Structure 214. Securely mount the upper support structure 214 onto the base structure 212, ensuring it is raised off the ground. The upper support structure 214 will serve as the mounting point for the photovoltaic (PV) array 216. Confirm that the upper support structure 214 is firmly attached and properly aligned.
Step 3: Install Balance of System (BOS) Components 222. Place the BOS components 222 (e.g., inverters, wiring, etc.) within the interior housing 220 of the base structure 212. This area will shield the components from weather effects. Verify that all BOS components 222 are adequately protected and positioned for ease of maintenance.
Step 4: Apply the Solar Reflective Material (Optional). If using a solar reflective material (SRM), apply it to panels or sheathing of the upper support structure 214. Confirm that the SRM effectively reflects sunlight onto the second side of the bifacial PV panel 218 for enhanced energy collection.
Step 5: Mount the Bifacial PV Panels. Attach at least one bifacial photovoltaic (PV) panel 218 to the upper support structure 214. Ensure that the panels 218 are securely mounted, with the first side oriented to face toward the sky, and the second side oriented to face away from the sky. Confirm that both sides of the bifacial PV panel 218, equipped with solar cells, are unobstructed for optimal solar energy collection.
Step 6: Final Checks. Inspect all components for secure attachment and alignment. Verify that all connections and installations meet safety and operational standards.

Weather by nature is unpredictable, but enough consistency exists among morning-noon-evening weather cycles to warrant a fresh look at the Effective Daily Yield (EDY) of fixed solar array geometries. While many factors affect PV production (angles of incidence, length of day, etc.), preliminary research suggests net daily yields of bifacial, virtual tracking geometrics can be equal or greater than coplanar, south-facing, single-sided arrays.

Traditional south-facing solar arrays are mostly offline on days when cloud buildup covers the sun. In contrast, the example increased-yield solar energy station has steadier bifacial virtual tracking designs that can produce as much or more energy at the end of the day (up to 20% under current calculations), all with the promise of a more streamlined array and other associated benefits.

Some of the technical benefits of the increased-yield solar energy station disclosed herein include a turnkey solution that simplifies the process of adopting solar energy, an increased energy yield within a smaller footprint, and ease of maintenance and snow removal. Additionally, the increased-yield solar energy station is readily expandable to accommodate a larger photovoltaic (PV) array of up to 15 KW total. The SolarShed™ version also offers 200 square feet of customizable space.

Some of the economic benefits of the increased-yield solar energy station include lowering the cost barrier for underserved communities, creating jobs within a designated HUBZone, and reducing the net cost of electricity.

Some of the social benefits of the increased-yield solar energy station include reducing the burden on the power grid, promoting the adoption of decarbonized energy in historically underrepresented regions, and localizing solar power rather than relying on large-scale solar farms, which often face resistance in the rural West. Additionally, solar energy produced by the increased-yield solar energy station increases public awareness and contributes to a positive image of renewable energy.

The increased-yield solar energy station can be further enhanced by determining the optimum non-traditional array geometry to maximize bifacial solar gain. The increased-yield solar energy station can also be further enhanced by determining optimum spacing between underside of bifacial panels and reflective roof, all while maintaining structural integrity of the PV array under snow and wind loads. The increased-yield solar energy station can also be further enhanced by the design of the reflective shell for the BOS enclosure. The increased-yield solar energy station can also be further enhanced by evaluating and testing BOS components to provide the best economical solution.

It is noted that the examples shown and described are provided for purposes of illustration and are not intended to be limiting. Still other examples are also contemplated.

1. An increased-yield solar energy station, comprising:
a base structure for contacting with the ground;
an upper support structure of the base structure raised off of the ground, the upper support structure for mounting a photovoltaic (PV) array to the base structure;
an interior portion of the base structure for at least partially shielding balance of system (BOS) components for the PV array from effects of weather; and
at least one bifacial photovoltaic (PV) panel of the PV array, the at least one bifacial PV panel mounted in a raised position relative to the upper support structure, the at least one bifacial PV panel having a first side oriented to face toward the sky, and a second side oriented to face away from the sky, both the first and second sides of the bifacial PV panel having solar cells for collecting solar energy.

2. The increased-yield solar energy station of claim 1, further comprising a solar reflective material (SRM) reflecting sunlight onto the second side of the bifacial PV panel.

3. The increased-yield solar energy station of claim 1, wherein the base structure is an outbuilding having sidewalls and a roof forming the interior portion, and a door for providing access to the BOS components within the interior portion.

4. The increased-yield solar energy station of claim 3, wherein the outbuilding is a storage shed.

5. The increased-yield solar energy station of claim 1, wherein the base structure is a geodesic structure formed by a network of interconnecting polygonal panels that form a spherical or semi-spherical shell over the interior portion, wherein a plurality of bifacial PV panels are positioned thereon such that at any given daylight hour one or more of the plurality of polygonal PV panels is at or near an optimum solar angle.

6. The increased-yield solar energy station of claim 1, wherein the base structure is a rectangular PV array formed by at least three angled facets that respectively face southeasterly, south, and southwesterly.

7. The increased-yield solar energy station of claim 1, wherein the base structure is a frame formed by a network of interconnecting frame members, at least some of the frame members contacting the ground, and at least some of the frame members forming the upper support structure over the interior portion.

8. The increased-yield solar energy station of claim 1, further comprising an active solar tracker to track available sunlight for energy production by the PV array.

9. The increased-yield solar energy station of claim 1, further comprising a virtual solar tracker to track available sunlight for energy production by the PV array.

10. The increased-yield solar energy station of claim 1, wherein the at least one bifacial PV panel is mounted to a gambrel roof of an outbuilding.

11. The increased-yield solar energy station of claim 10, wherein a solar reflective material (SRM) is applied as a coating to the gambrel roof of the outbuilding.

12. The increased-yield solar energy station of claim 10, wherein the at least one bifacial PV panel is mounted above a top surface of the gambrel roof of the outbuilding at a distance such that sunlight reaches the solar cells on the second side of the at least one bifacial PV panel oriented to face away from the sky.

13. The increased-yield solar energy station of claim 1, wherein the at least one bifacial PV panel forms at least one interconnecting polygonal panels of a geodesic structure.

14. The increased-yield solar energy station of claim 13, wherein the interconnecting polygonal panels of the geodesic structure are separated from one another at a distance such that sunlight passes into an interior of the geodesic structure to reach a BOS component enclosure at a locus of the geodesic structure and at least partially reflects onto an underside of the at least one bifacial PV panel.

15. The increased-yield solar energy station of claim 13, wherein the interconnecting polygonal panels are separated from one another at a distance that permits wind to pass between the interconnecting polygonal panels and decrease effective wind load on the geodesic structure.

16. The increased-yield solar energy station of claim 13, wherein a solar reflective material (SRM) is applied as a coating to a BOS component enclosure located at a locus of the geodesic structure.

17. An increased-yield solar energy station, comprising:
a base structure for contacting with the ground, the base structure being one of an outbuilding, a geodesic structure, and a frame formed by a network of interconnecting frame members;
an upper support structure of the base structure raised off of the ground, the upper support structure for mounting a photovoltaic (PV) array to the base structure;
an interior portion of the base structure for at least partially shielding balance of system (BOS) components for the PV array from effects of weather;
at least one bifacial photovoltaic (PV) panel of the PV array, the at least one bifacial PV panel mounted in a raised position relative to the upper support structure, the at least one bifacial PV panel having a first side oriented to face toward the sky, and a second side oriented to face away from the sky, both the first and second sides of the bifacial PV panel having solar cells for collecting solar energy; and
a solar reflective material (SRM) on the upper support structure, the SRM reflecting sunlight from the upper support structure onto the second side of the bifacial PV panel.

18. The increased-yield solar energy station of claim 17, wherein the at least one bifacial PV panel is mounted above a top surface of the upper support structure at a distance such that sunlight reaches the solar cells on the second side of the at least one bifacial PV panel oriented to face away from the sky.
